(19) United States
(12) Patent Application Publication
(10) Pub. No.: US 2017/0093616 A1
(43) Pub. Date: Mar. 30, 2017

(54) METHOD AND APPARATUS FOR PROVIDING IN-SERVICE FIRMWARE UPGRADABILITY IN A NETWORK ELEMENT

(71) Applicant: TELEFONAKTIEBOLAGET L M ERICSSON (PUBL), Stockholm (SE)

(72) Inventors: Desmond Yan, Vancouver (CA); Tak Kuen Tang, Vancouver (CA); Thomas Ng, Richmond (CA)

(21) Appl. No.: 14/867,762

(22) Filed: Sep. 28, 2015

(51) Int. Cl. H04L 12/24; H04L 12/803; H04L 12/725

(52) U.S. Cl. CPC H04L 41/082; H04L 45/306; H04L 47/125

(57) ABSTRACT

A system and method for providing in-service firmware upgradability in a network element having a programmable device configured to support a plurality of application service engines or instances. A static core infrastructure portion of the programmable device is architected in a multi-layered functionality for effectuating a packet redirection scheme for packets intended for service processing by a particular application service engine that is being upgraded, whereby the remaining application service engines continue to provide service functionality without interruption.

### FIELD OF THE DISCLOSURE

The present disclosure generally relates to the field of firmware upgrading. More particularly, and not by way of any limitation, the present disclosure is directed to a method and apparatus for providing in-service firmware upgradability in a piece of equipment, e.g., a network element.

### BACKGROUND

Use of programmable devices in various applications, including network router applications, has been steadily increasing due to a number of benefits such as dedicated performance, quick time-to-market and prototyping, reprogrammability, low NRE (nonrecurring engineering) cost, etc. For example, Field-Programmable Gate Arrays (FPGAs) have become particularly ubiquitous in implementations where they can be useful for off-loading processor-intensive applications that a CPU host may not be optimized in its design to perform.

One desirable feature of a reprogrammable device is that its firmware may be re-downloaded and upgraded as needed. However, in a typical upgrade scenario, the device is powered down or taken off-line, which can result in unacceptable levels of downtime and concomitant disruption of service.

### SUMMARY

The present patent disclosure is broadly directed to a system, apparatus and method for providing in-service firmware upgradability in a network element having a programmable device configured to support a plurality of application service engines or instances. A static core infrastructure portion of the programmable device is architected in a multi-layered functionality for effectuating an internal packet redirection scheme for packets intended for service processing by a particular application service engine that is being upgraded, whereby the remaining application service engines continue to provide service functionality without interruption.

In one aspect, an embodiment of a programmable device adapted to perform an application service is disclosed. The claimed embodiment comprises, inter alia, an aggregation layer component configured to distribute ingress packets received from a host device to a plurality of crossbar distributors forming a crossbar layer component of the programmable device. An admission layer component is operably coupled between a plurality of application service engines and the crossbar layer component for facilitating transfer of ingress packets and processed egress packets, wherein each crossbar distributor may be configured by the host device in either a default mode or a redirect mode of operation. When configured to operate in default mode, a crossbar distributor forwards or bridges the ingress packets to a specific corresponding application service engine for processing. On the other hand, if a particular crossbar distributor is configured to operate in a redirect mode, it is adapted to distribute received ingress packets to a subset of the plurality of the application service engines excluding the specific application service engine corresponding to the particular crossbar distributor, which specific application service engine may be undergoing a reconfiguration or upgrading process.

In another aspect, an embodiment of a method operating at a network element configured to support in-service application upgradability is disclosed. The claimed method comprises, inter alia, receiving, at a first-level ingress distributor of a programmable device of the network element, ingress packets from a host component coupled to the programmable device, each ingress packet having a first-level distribution tag, a second-level distribution tag and a host identifier configured by the host component, wherein the programmable device comprises a dynamic component including a plurality of application service engines, each configured to execute an instance of an application service with respect to the ingress packets. Responsive to the first-level distribution tag, an ingress packet may be forwarded by the first-level ingress distributor to a specific one of a plurality of second-level ingress distributors, each corresponding to a particular application service engine of the plurality of application service engines. A determination may be made if a particular second-level ingress distributor is in a default mode or in a redirect mode, wherein the redirect mode corresponds to a condition in which an application service engine associated with the particular second-level ingress distributor is in a state of unavailability and the default mode corresponds to a condition in which the application service engine corresponding to the particular second-level ingress distributor is in an active state. If the particular second-level ingress distributor is in default mode, the ingress packets are forwarded to the particular application service engine associated with or corresponding to the particular second-level ingress distributor for processing. Otherwise, if the particular second-level ingress distributor is in redirect mode, the ingress packets are distributed to remaining active application service engines for processing, responsive to the second-level distribution tags of the ingress packets. In one example implementation, the first-level distribution and the second-level distribution tags each comprise N-bit random numbers provided by the host component, which tags may be used for indexing into respective Look-Up Tables (LUTs) for determining where the ingress packets should be forwarded or redirected.

In another aspect, an embodiment of a network element is disclosed which comprises, inter alia, one or more processors and a programmable device supporting a plurality of application service engines configured to execute an application service, wherein the programmable device comprises a layered packet distribution mechanism that includes an aggregation layer component for distributing ingress packets to a crossbar layer component configured to selectively bypass a particular application service engine and redirect the ingress packets to remaining application service engines. A persistent memory module coupled to the one or more processors and having program instructions may be included for configuring the aggregation layer and crossbar layer components under suitable host control in order to effectuate in-service firmware upgradability of the programmable device.

In a still further aspect, an embodiment of a non-transitory, tangible computer-readable medium containing instructions stored thereon is disclosed for performing one or more embodiments of the methods set forth herein. In one variation, an embodiment of a network element having in-service firmware upgrade capability may be operative in a service network that is architected as a Software Defined Network (SDN). In another variation, the service network may embody non-SDN architectures. In still further variations, the service network may comprise a network having service functions or nodes that may be at least partially virtualized.

Benefits of the present invention include, but not limited to, providing non-stop application service functionality in a network element even during an upgrade of service firmware embodied in one or more programmable devices of the network element. The multi-layered core infrastructure of a programmable device according to an embodiment herein advantageously leverages recent advances in partial reconfiguration of such devices whereby equipment-level requirements such as high availability, etc. may be realized. Further features of the various embodiments are as claimed in the dependent claims. Additional benefits and advantages of the embodiments will be apparent in view of the following description and accompanying Figures.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts an example network element wherein one or more embodiments of the present patent application may be practiced for effectuating in-service application or service upgradability with respect to a programmable device disposed in the example network element;

FIG. 2 depicts further details of an example network element provided with in-service upgradability according to an embodiment;

FIG. 3 depicts a block diagram of an example programmable device supporting a plurality of application service engines that may be used in a network element of FIG. 1 or FIG. 2 according to an embodiment;

FIGS. 4A and 4B depict example ingress and egress packet structures according to an embodiment of the present invention for effectuating a multi-level or multi-layered packet distribution mechanism within a programmable device;

FIG. 4C depicts an example look-up table (LUT) structure that may be indexed based on multi-level distribution tags appended to example ingress packet structures of FIG. 4A;

FIG. 5A depicts a block diagram of a network element with further details of an example programmable device supporting four application service engines in an illustrative embodiment;

FIGS. 5B and 5C depict example LUT structures based on a 4-bit distribution tag arrangement operative in the embodiment of FIG. 5A in an illustrative scenario;

FIGS. 5D and 5E depict an example LUT structure and redistribution scheme based on a 4-bit distribution tag arrangement for redirecting ingress packets in the embodiment of FIG. 5A where one of the application service engines, e.g., Engine-0, is unavailable or otherwise decommissioned in an illustrative scenario;

FIGS. 6A and 6B depict flowcharts of various blocks, steps, acts and functions that may take place at a programmable device and/or in a network element including the programmable device for supporting in-service application or firmware upgradability according to an embodiment; and

FIG. 7 depicts a flowchart of a scheme for effectuating in-service application or firmware upgradability according to an embodiment of the present invention.

### DETAILED DESCRIPTION OF THE DRAWINGS

In the following description, numerous specific details are set forth with respect to one or more embodiments of the present patent disclosure. However, it should be understood that one or more embodiments may be practiced without such specific details. In other instances, well-known circuits, subsystems, components, structures and techniques have not been shown in detail in order not to obscure the understanding of the example embodiments. Accordingly, it will be appreciated by one skilled in the art that one or more embodiments of the present disclosure may be practiced without such specific components-based details. It should be further recognized that those of ordinary skill in the art, with the aid of the Detailed Description set forth herein and taking reference to the accompanying drawings, will be able to make and use one or more embodiments without undue experimentation.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element is capable of performing or otherwise structurally arranged to perform that function.

As used herein, a network element or node (e.g., a router, switch, bridge, etc.) may comprise a piece of networking equipment, including hardware and software that communicatively interconnects other equipment on a network (e.g., other network elements, end stations, etc.). Some network elements may comprise “multiple services network elements” that provide support for multiple networking functions (e.g., routing, bridging, switching, Layer-2 aggregation, session border control, Quality of Service, and/or subscriber management, and the like), and/or provide support for multiple application services (e.g., data, voice, and video). In some implementations, a network element may also include a network management element and/or vice versa. End stations (e.g., servers, workstations, laptops, notebooks, palm tops, mobile phones, smartphones, multimedia phones, Voice Over Internet Protocol (VOIP) phones, user equipment, terminals, portable media players, GPS units, gaming systems, set-top boxes, etc.) me be operative to communicate via any number of network elements or service elements in order to access or consume content/services provided over a packet-switched wide area public network such as the Internet through suitable service provider access networks. Some end stations (e.g., subscriber end stations) may also access or consume content/services provided on virtual private networks (VPNs) overlaid on (e.g., tunneled through) the Internet. Whereas some network nodes or elements may be disposed in wired communication networks, others may be disposed in wireless infrastructures. Further, it should be appreciated that example network nodes may be deployed at various hierarchical levels of an end-to-end network architecture. Regardless of the specific implementation, one skilled in the art will recognize that an embodiment of the present patent disclosure may involve a network element (e.g., a router) wherein one or more services or service functions having multiple instances (i.e., “service function replicas”) that may be placed or instantiated with respect to one or more packet flows (e.g., bearer traffic data flows, control data flows, etc.) traversing through the network element according to known or otherwise preconfigured service requirements and/or dynamically (re)configurable service rules and policies. Additionally and/or alternatively, one or more embodiments of the present disclosure may be practiced in the context of network elements disposed in a service network that may be implemented in an SDN-based architecture, which may further involve varying levels of virtualization, e.g., virtual appliances for supporting virtualized service functions or instances in a suitable network function virtualization (NFV) infrastructure. In a still broader aspect, an embodiment of the present patent disclosure may involve a generalized packet processing node or equipment wherein one or more packet processing functionalities, e.g., services, applications, or application services, with respect to a packet flow may be off-loaded to a reconfigurable device that may require in-service upgradability.

One or more embodiments of the present patent disclosure may be implemented using different combinations of software, firmware, and/or hardware. Thus, one or more of the techniques shown in the Figures (e.g., flowcharts) may be implemented using code and data stored and executed on one or more electronic devices (e.g., an end station, a network element, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such electronic devices may typically include a set of one or more processors coupled to one or more other components, such as one or more storage devices (non-transitory machine-readable storage media), user input/output devices (e.g., a keyboard, a touch screen, a pointing device, and/or a display), and network connections. The coupling of the set of processors and other components may be typically through one or more buses and bridges (also termed as bus controllers), arranged in any known (e.g., symmetric/shared multiprocessing) or heretofore unknown architectures. Thus, the storage device or component of a given electronic device may be configured to store code and/or data for execution on one or more processors of that electronic device for purposes of implementing one or more techniques of the present disclosure.

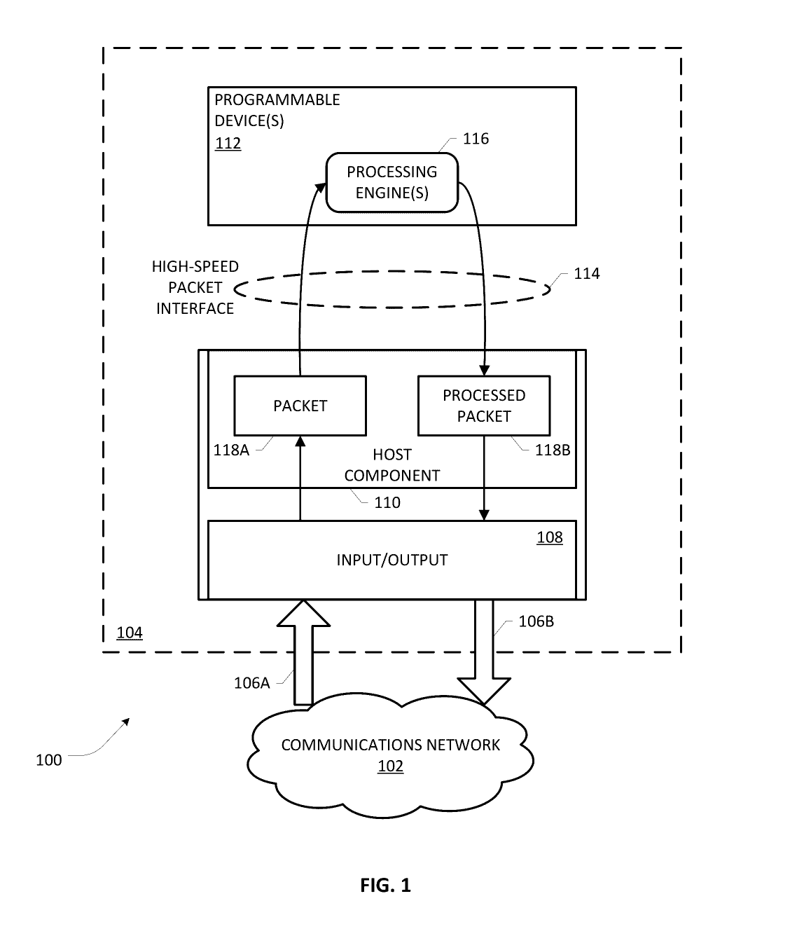

Turning now to FIG. 1, depicted therein is an example network environment 100 including a communications network 102 wherein a network element or service node 104 is operative to provide one or more application services with respect to ingress packet traffic 106A from the network 102 and output processed packet traffic, i.e., egress packet traffic 106B to the network 102 via suitable input/output interfacing 108, which may include wireline and/or wireless technologies. Without limitation, strictly by way of illustration, an application service may comprise performing at least one of an Internet Protocol security (IPsec) service, Deep Packet Inspection (DPI) service, Firewall filtering service, Intrusion Detection and Prevention (IDP) service, Network Address Translation (NAT) service, and a Virus Scanning service, etc. for the incoming packets, which may be off-loaded to specialized entities or modules that may be realized as one or more service processing engines 116 implemented on one or more programmable or reconfigurable devices 112 for efficiency, redundancy, scalability, etc. The portion of the network element or node 104, e.g., including a central processing unit (CPU) or network processing unit (NPU), that off-loads application service processing to the programmable device(s) 112 may be referred to as a host component 110, which may be coupled to the programmable device(s) 112 via a suitable high-speed packet interface 114 to minimize latency.

In the context of the present patent application, a programmable device for effectuating application services on behalf of a host component may comprise a variety of (re)configurable logic devices including, but not limited to, Field-Programmable Gate Array (FPGA) devices, Programmable Logic Devices (PLDs), Programmable Array Logic (PAL) devices, Field Programmable Logic Array (FPLA) devices, and Generic Array Logic (GAL) devices, etc. At least portions of such devices may be responsible for executing application service functionalities and may be configured to be upgradable either in field, in lab, and/or remotely. By way of illustration, one or more embodiments will be described in detail hereinbelow by taking occasional reference to FPGA implementations, although one skilled in the art will recognize that the teachings herein may be applied in the context of other types of programmable devices as well, mutatis mutandis.

It should be appreciated that FPGAs may be implemented as critical components in virtually every high-speed digital design, including the design of router applications such as Non-Stop Routing (NSR), In-Service Software/Firmware Upgradability (ISSU/ISFU), etc. Unlike Application-Specific Integrated Circuits (ASICs), an FPGA-based application service implementation may be configured to ensure maximum availability with minimal downtime resulting from device maintenance and/or upgrade processes. By way of illustration, an FPGA implementation may be used in the context of router applications for providing the necessary processing with respect to services such as, inter alia, IPSec encapsulation where the CPU/NPU off-loads applicable packet encryption processes, which typically use CPU-intensive techniques.

Since the FPGA firmware is downloadable, it advantageously provides an upgrade path from software release to software release during the course of its deployment. For example, the complete FPGA binary file may be (re-)downloaded using in-system programming where the FPGA chip goes through a chip-level reset. During the FPGA upgrade process, therefore, services/applications provided by the FPGA will become unavailable for a period of time, which only increases with the ever-increasing FPGA logic gate capacity. Because newer FPGA devices supporting complex service/application functionalities may comprise tens of millions of Logic Cells (with the resultant FPGA Configuration Bitstream lengths being as large as 400 Mbits or more), ensuing disruption of services in the event of an upgrade or replacement significantly impairs the performance of the network equipment, especially when the FPGA functionality is deployed in datapath processing (e.g., on a line card or service card in NSR-capable equipment).

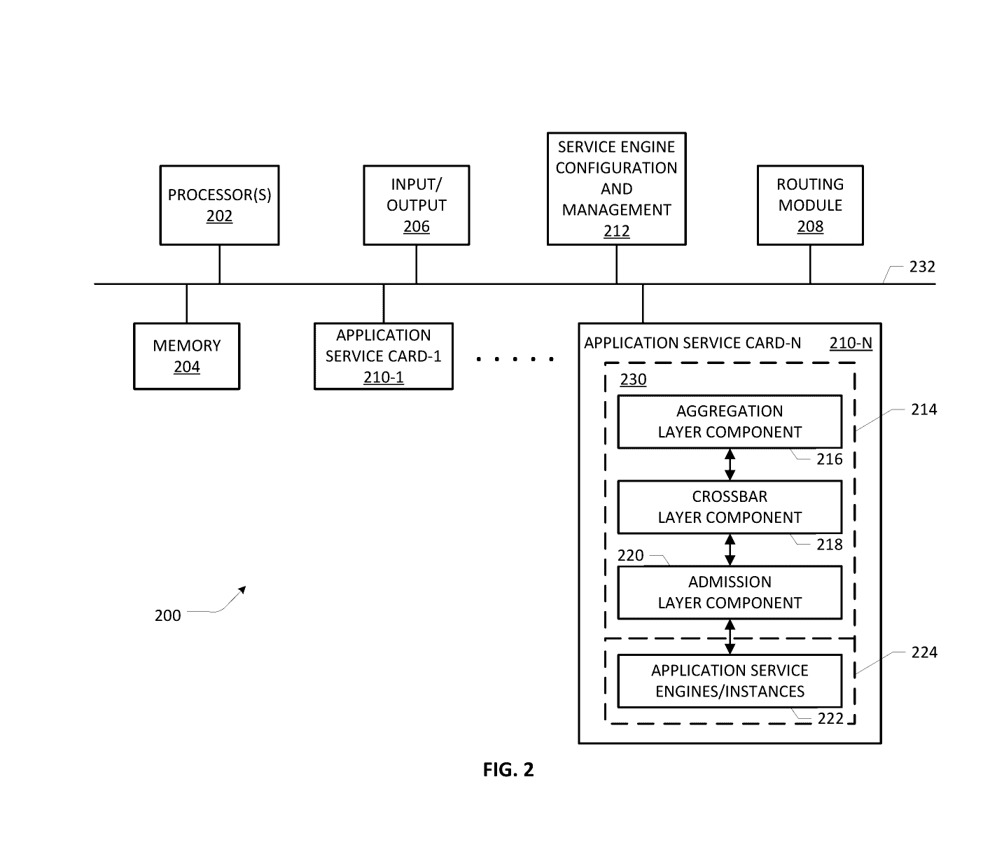

FIG. 2 depicts further details of an example network element 200 wherein in-service upgradability for a programmable device may be provided according to an embodiment. Broadly, the logic gates of a programmable device may be partitioned into static and dynamic portions or compartments, wherein the static portion forming the programmable device's core infrastructure may be configured to support an internal, layered packet distribution mechanism for distributing ingress packets to the dynamic portion comprising a pool of application service engines for processing the ingress packets according to one or more application services. In one arrangement, each of the application service engines may be provided in a reconfigurable partition, allowing for individual upgrading/replacement while the remaining the application service engines or instances may continue to be active. Accordingly, the overall service processing may continue to be performed by the programmable device while an upgrade procedure is taking place, albeit at a lower throughput since at least one of the application service engines is being replaced, upgraded, updated, reconfigured, or otherwise decommissioned, thereby mitigating or eliminating the negative effects of service disruption encountered in typical applications.

One skilled in the art will recognize upon reference hereto that network element 200 is illustrative of a more particularized arrangement of the node 104 disposed in communications network 102 shown in FIG. 1. One or more processors 202 coupled to suitable memory (e.g., persistent memory 204) having executable program instructions thereon may comprise a host component of the network element 200 that may be configured to off-load service processing to one or more application service cards 210-1 to 210-N, wherein each application service card may include one or more programmable devices that may be configured in a layered architecture for facilitating in-service upgradability as will be set forth in detail further below. For purposes of the present patent application, the terms “In-Service Firmware Upgrade” (ISFU), “In-Service Application Upgrade” (ISAU), or “In-Service Software Upgrade” (IFSU), or terms of similar import may be used somewhat interchangeably, wherein an application/service engine instance may be dynamically reconfigured or upgraded while the underlying static core infrastructure of a programmable device remains the same.

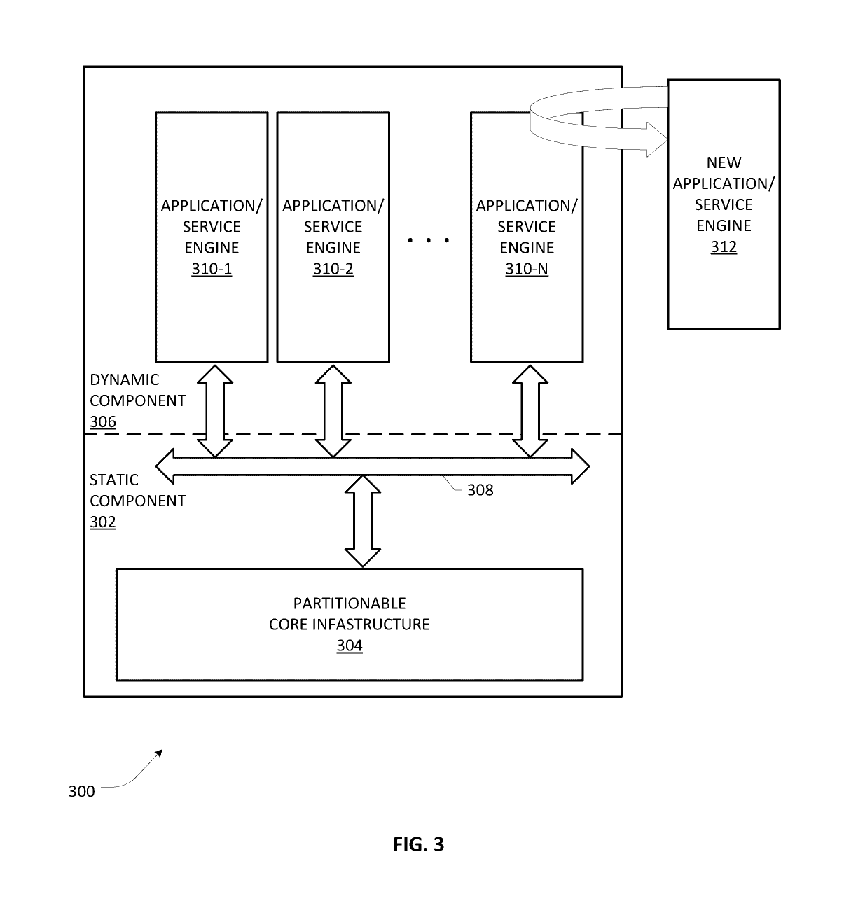

As an example router implementation, network element 200 may include one or more routing modules 208 for effectuating packet routing according to known protocols operating at one or more OSI layers of network communications. Additionally, suitable input/output modules 206 may be provided for interfacing with a communications network, which may comprise any combination or subcombination of one or more extranets, intranets, the Internet, ISP/ASP networks, service provider networks, datacenter networks, call center networks, and the like, as described hereinabove. By way of illustration, application service cards 210-1 to 210-N as well as the remaining portions of the network element 200 may be interfaced using suitable buses, interconnects, high-speed packet interfaces, etc., collectively shown as transmission infrastructure 232 in FIG. 2. Focusing on an example application service card 210-N, a programmable device 230 disposed therein may be configured as a multi-layered or multi-level static core infrastructure portion 214 and a dynamic portion 224, which may be partitioned on an application-by-application basis if multiple applications or services are supported by the programmable device 230. In accordance with the teachings herein, the static portion 214 may be configured as an aggregation layer component 216, a crossbar layer component and an application admission layer component 220, which interoperate together to form a layered packet distribution mechanism for distributing ingress packets to one or more application service engines 222 of the dynamic portion 224. A service engine configuration and management module 212 may be embodied in a persistent memory of the host component node 200 that is operative to configure the static core infrastructure 214 of the programmable device 230 for facilitating packet routing/distribution in normal (e.g., default) operation (where all application service engines are active and configured to receive ingress packets) as well as in redirect/redistribution mode where an application service engine is being replaced or upgraded, thereby being unavailable for a time period. FIG. 3 depicts another view of an example programmable device 300 operative to support a plurality of application service engines 310-1 to 310-N that form a dynamic component or compartment 306, which may be coupled to a static component 302 comprising a partitionable core infrastructure 304 that is representative of the foregoing layered architecture. An internal high-speed interface 308 may be provided to optimize packet throughput (with respect to ingress packets requiring service processing as well as processed egress packets returning to a host device) between the two compartments, which may be implemented using device resources such as programmable interconnects, etc., for effectuating internal packet (re)distribution as will be described in additional detail below. A new application or service engine instance 312 is illustrated for replacing or upgrading an individual instance, e.g., application service engine 310-N, of the plurality of application service engines as a new release of application service software or firmware, which may be downloaded for upgrading the engines one by one in the dynamic portion 306 of the programmable device 300.

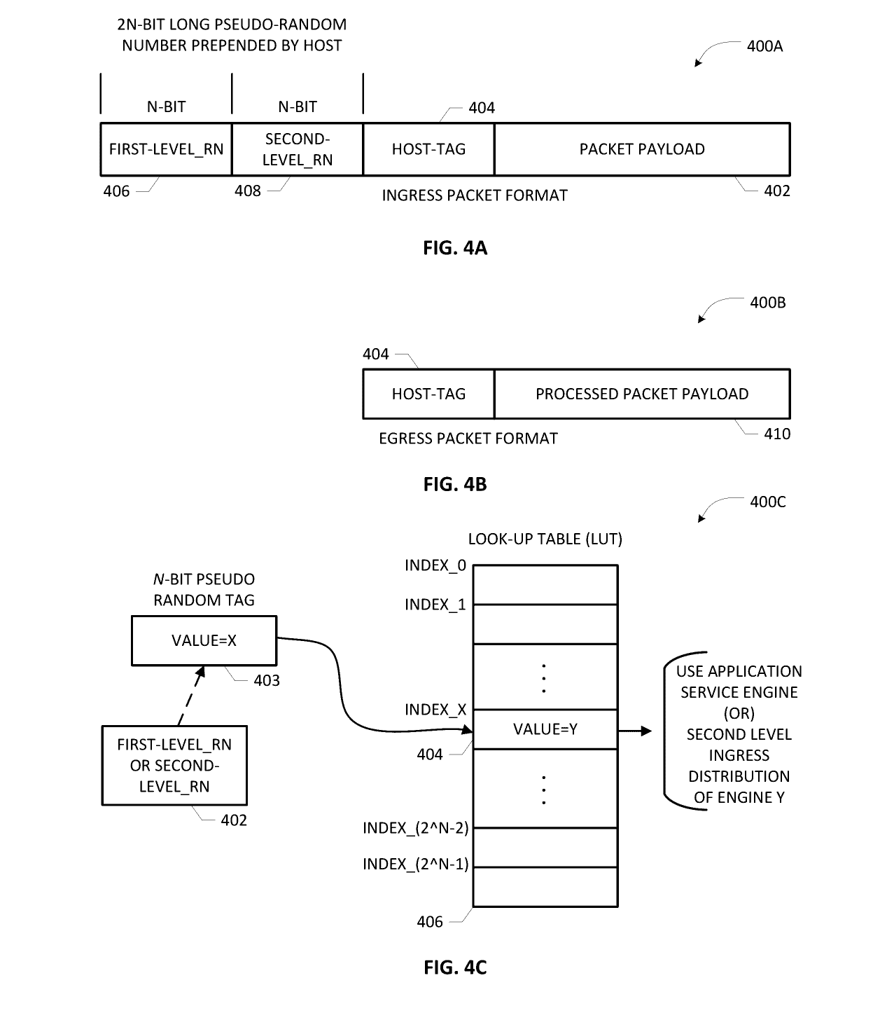

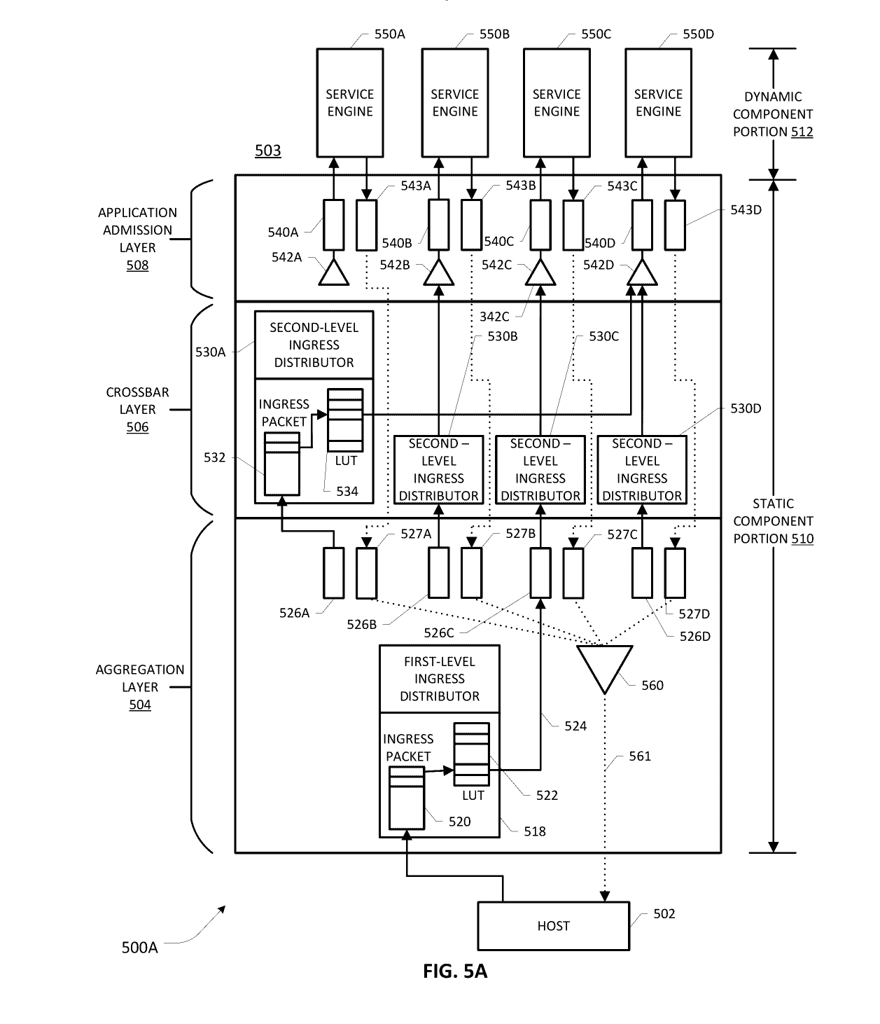

Taking reference to both FIGS. 2 and 3, in addition to FIGS. 4A-4C described in the following sections, an example embodiment of the present invention will now be set forth herein. In order to facilitate load balancing of packets among a plurality of service engines, e.g., application service engines 310-1 to 310-N (collectively referred to as N service/application engines), preferably, an indicium or tag based on random number generation may be appended (e.g., prepended) by the host component to each ingress packet of a packet flow. In one implementation, the random number tag may be configured as a 2-n tag that is subdivided into two equal n-bit numbers, each being used for a particular level of packet distribution that is facilitated by suitable data structures such as, e.g., First-In-First-Out (FIFO) structures, hash tables, and/or associated scheduling mechanisms. FIGS. 4A and 4B depict example ingress and egress packet structures according to an embodiment of the present invention for effectuating a multi-level or multi-layered packet distribution mechanism within a programmable device. An ingress packet 400A containing a payload portion 402 is provided with a header having a 2-n bit long random or pseudo-random number tag generated by an appropriate module of the host component, which may be subdivided into a {First-level_RN} tag 406 and a {Second-level_RN} tag 408 as part of the packet header field. A Host-tag field 404 is also defined for purposes of tracking the packets by the host, which in one example implementation will remain untouched during the processing by the service engines and returned back to the host component. On the other hand, in a processed egress packet 400B containing a processed packet payload portion 410, both the First-level_RN and Second-level_RN tags are removed. Under normal processing, only First-level_RN is used for distribution, while the Second-level_RN is strictly used during ISFU upgrade, as will be described below. It should be appreciated that the host component (e.g., including CPU/NPU) may be advantageously configured to attach a (pseudo-)random tag to the ingress packets, which in one implementation may be provided as a hashed result based on the packet type and format, e.g., IPv4, IPv6, etc. As one skilled in the art will recognize, in the example RN tag implementation, a length of n bits allows a maximum N=2̂n (or, 2ⁿ) service/application engines to be supported in a programmable device, if a 1-to-1 mapping correspondence is deployed.

Returning to FIG. 2, the aggregation layer component 216 is preferably configured to handle a suitable external interface to the host component or device (or, “host” for short) by which ingress packets are received for processing and processed egress packets are returned to the host. In its ingress direction, packets may be distributed to a first-level FIFO pool based on the First-level_RN tag. In one example arrangement, packet distribution may be based on a table-lookup mechanism (e.g., via a Look-Up Table or LUT structure, which may be implemented in hardware, software, firmware, etc. using appropriate combinational logic) that may be configured by a host module, e.g., module 212 shown in FIG. 2, under suitable program instructions. Those skilled in the art will appreciate that a table lookup mechanism may be advantageous in allowing the host to have full control on ingress packet distribution (e.g., using suitable weigh-based distribution) for achieving load balancing as needed. In one arrangement, the host component may be configured to fill up LUT entries at initialization time. The value given by the First-level_RN tag may be used as an index to access the LUT's entry which contains the pre-programmed address of a second-level FIFO distributor that corresponds to a specific application/service engine number, Y.

Continuing to refer to FIG. 2, the crossbar layer component 218 may be configured to include a plurality of second-level ingress distributors (also referred to as crossbar distributors) that are responsible for re-distributing data from first-level FIFOs to a pool of second-level FIFOs, each corresponding to a particular application/service engine in a 1-to-1 relationship. Preferably, each crossbar distributor may be configured to operate in one of two modes. In a default/normal mode of operation, the crossbar distributor is configured to simply bridge packets from the first-level ingress FIFO to the corresponding second-level ingress FIFO (e.g., packet forwarding). In this mode of operation, no lookup for the destination is required. In a redirect mode of operation, the crossbar distributor is configured to query another LUT responsive to the Second-level_RN tag as an index based on hashing in order to obtain the destination of a second-level FIFO. Once the destination is obtained or otherwise determined, the crossbar distributor is configured to request admission from a scheduler associated with the destination second-level FIFO, which corresponds to a specific application service engine, as noted previously.

The application admission layer component 220 of the static core infrastructure of the programmable device 230 may be configured to include the engine-specific second-level FIFO pool, wherein each second-level ingress FIFO is equipped with a scheduler that services requests from the FIFO-crossbar distributor layer component 218. In one example implementation, scheduling may be performed by a Round Robin (RR) scheduler configured to serve the requests received from one or more crossbar distributors. Based on the dual-mode operation of the crossbar distributors, it should be appreciated that an i^{th} scheduler of the application admission layer component 220 may receive requests in a normal/default operation (e.g., non-upgrade scenario) only from the corresponding i^{th} second-level ingress distributor of the crossbar layer component 218. On the other hand, however, during upgrade of a j^{th} service/application engine, the i^{th} scheduler may receive requests from both i^{th} and j^{th} distributors due to the second-level LUT entries based on the Second-level_RN indexing. In other words, the requests that would have gone to the j^{th} scheduler (for servicing by the associated j^{th} application service engine) are now redistributed or redirected to the remaining active application service engines (via their corresponding schedulers). In one example embodiment, only one application/service engine may be configured to be upgraded at any single time such that an application admission scheduler may receive requests only from its corresponding second-level ingress distributor (in default mode) and requests from the second-level ingress distributor (in redirect mode) corresponding to the particular application/service engine being upgraded. It should be appreciated, however, that multiple engines may also be upgraded but such an arrangement may result in unacceptable performance degradation (since the remaining active engines/schedulers will be burdened with additional extra loads).

Turning to FIG. 4C, shown therein is an example packet distribution mechanism 400 based on a LUT structure 406 that may be configured by a host module either as a first-level LUT used by the aggregation layer component 216 for facilitating the distribution of ingress packets to a pool of first-level FIFOs (each corresponding to a particular crossbar distributor) and/or as a second-level LUT used by the crossbar layer component 218 for redirection/redistribution of ingress packets to a pool of second-level FIFOs (corresponding to the pool of admission layer schedulers and application service engines) in accordance with an embodiment of the present patent application. Reference numeral 402 refers to a First-level_RN or a Second-level_RN, which may be referred to as first-level or second-level distribution tags, respectively, each containing a value 403 comprising an n-bit random number (e.g., based on non-deterministic processes) or pseudo-random number (e.g., based on deterministic causation) that can be indexed into a hash-based LUT entry as described hereinabove. For an n-bit length, the LUT structure 406 therefore comprises indices ranging from {Index_0} to {Index_2⁽ⁿ⁾−1} wherein a particular index may point to a location containing a suitable destination value Y. As noted previously, the destination value may direct the packets to a first-level FIFO or its associated crossbar distributor (in a first-level LUT arrangement) or to a second-level FIFO or its associated application service engine (in a second-level LUT arrangement). Although a LUT-based packet direction/distribution mechanism involving two separate LUTs is exemplified herein, it should be understood that various other structures, e.g., combination LUTs, 2-dimensional arrays, look-up matrices, etc., implemented in hardware, software and/or firmware, may also be provided in additional or alternative embodiments for purposes herein within the scope of the present patent application.

Upon completion of application service processing, processed egress packets 400B may be returned to the host component via a default return path that may be effectuated in a number of ways wherein the prepended host identifier tag 404 may be used for properly directing the egress packets all the way to the correct host component and/or for tracking purposes. Accordingly, in one arrangement, egress packets may simply be bridged from a pool of second-level egress FIFOs of the application admission layer 220 (that receive the processed packets from corresponding application service engines) to the corresponding pool of first-level egress FIFOs (due to the 1-to-1 correspondence relationship in the FIFO crossbar layer 218 in normal mode similar to the ingress FIFO relationship). Thereafter, the aggregation layer 216 may utilize suitable scheduling techniques (e.g., RR scheduling) to retrieve the packets from the first-level egress FIFOs and forward them to the host component via applicable high-speed packet interfacing.

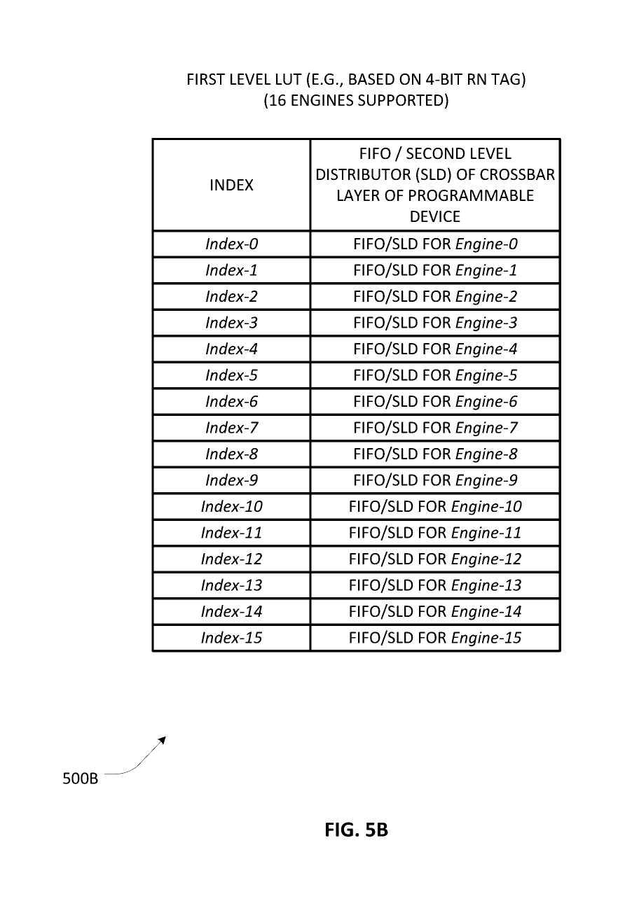

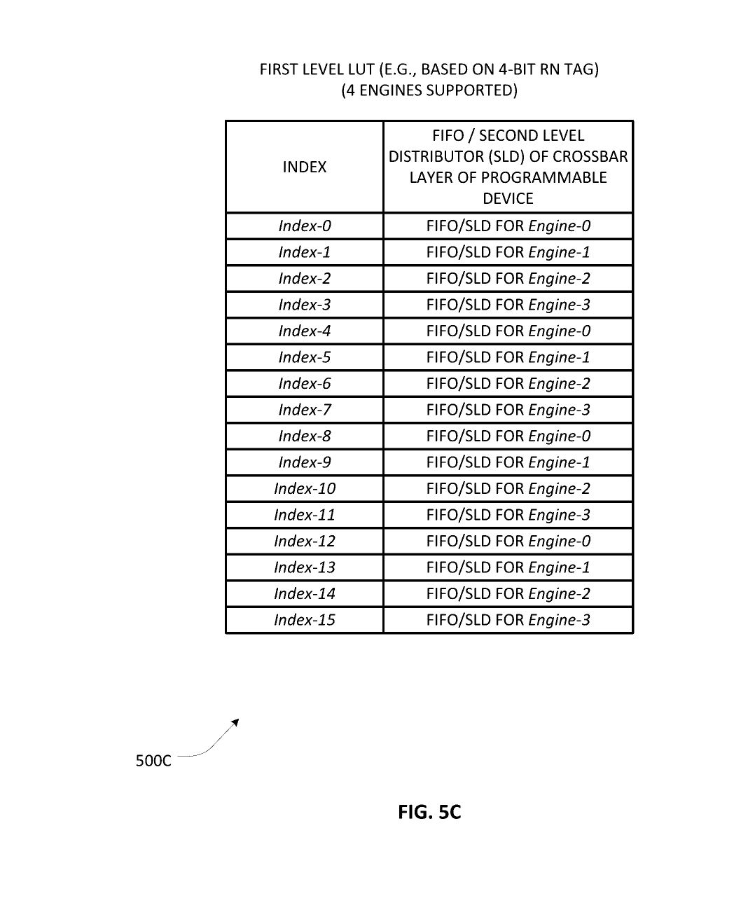

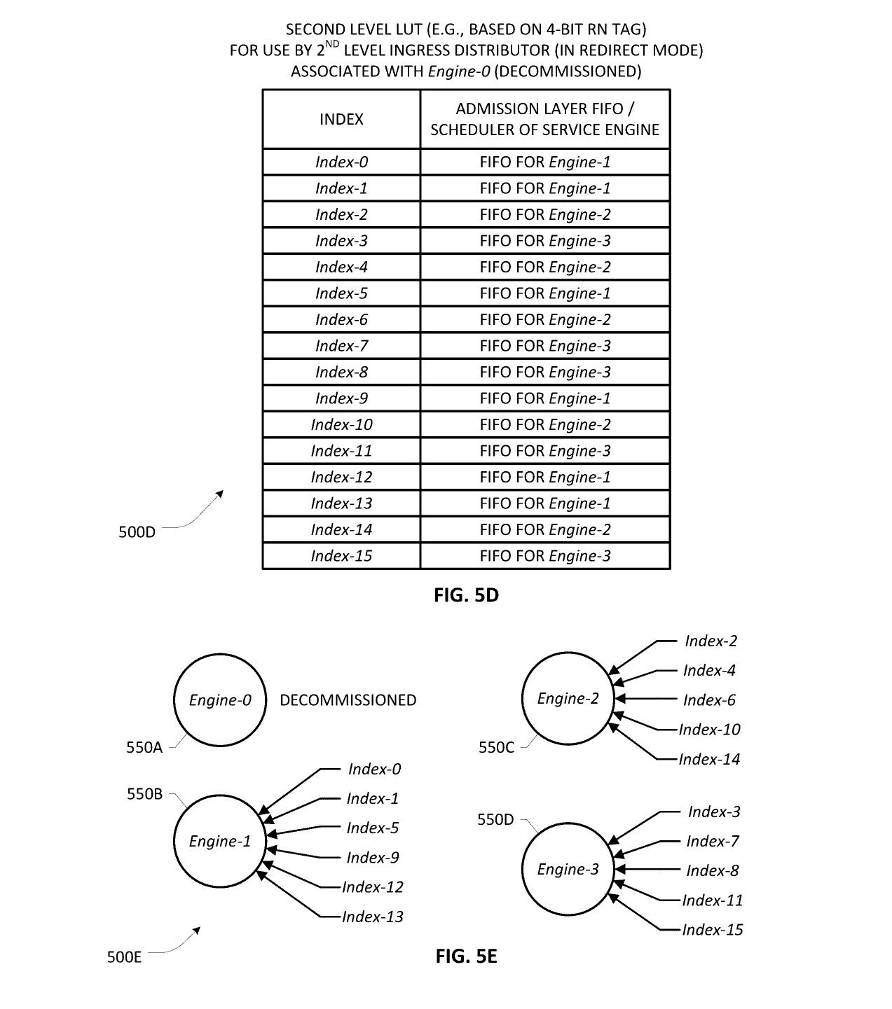

An example programmable device using a 4-bit based packet distribution scheme for supporting ISFU capability is provided below by way of illustration. FIG. 5A depicts a block diagram of an apparatus 500A, e.g., a network element, node or other equipment, with further details of an example programmable device 503 according to an embodiment. A static component portion 510 comprises an aggregation layer 504, a crossbar layer 506 and an application admission layer 508 that are representative of the multi-layered static core infrastructure 214 described hereinabove. A dynamic component portion 512 is illustratively shown as comprising four application service engines 550A-550D for the sake of simplicity, although up to 16 application service engines may be supported in a 4-bit tag based packet distribution scheme. As there are four application service engines 550A-550D, a pool of four corresponding sets of second-level FIFOs are provided as part of the application admission layer 508, wherein each set includes an ingress FIFO and an egress FIFO to handle the ingress packets and egress packets, respectively. Application service engine 550A is therefore associated with FIFO set 540A, 543A a 1-to-1 correspondence relationship, wherein the ingress FIFO 540A is serviced by a scheduler 542A associated therewith. Likewise, application service engine 550B is associated with FIFO set 540B, 543B (with the ingress FIFO 540B being serviced by a scheduler 542B), application service engine 550C is associated with FIFO set 540C, 543C (with the ingress FIFO 540C being serviced by a scheduler 542C), and application service engine 550D is associated with FIFO set 540D, 543D (with the ingress FIFO 540D being serviced by a scheduler 542D), in similar respective 1-to-1 correspondence relationships. Also, because of the 1-to-1 correspondence relationship between the second-level FIFOs and crossbar distributors (also referred to as second-level ingress distributors), four crossbar distributors 530A-530D are illustratively shown as part of the crossbar layer 506 of the programmable device 503, each of which is associated with a corresponding set of first-level FIFOs 526A/527A to 526D/527D wherein FIFOs 526A-526D are operative for ingress packet flow while FIFOs 527A-527D are operative for egress packet flow.

Aggregation layer 504 may be configured to include a first-level ingress distributor 518 that is interfaced with a host 502, wherein an ingress packet 520 is provided with a 4-bit first-level distribution tag and a 4-bit second-level distribution tag as described previously. A first-level LUT 522 is associated with the first-level ingress distributor 518 for determining a specific first-level ingress FIFO (and corresponding second-level ingress distributor or crossbar distributor). FIG. 5B depicts an example first-level LUT structure 500B based on a 4-bit random number tag where 16 application service engines, Engine-0 to Engine-15, are supported. Since the size of the LUT structure 500B matches the total number of the application service engines, each index of the 16 indexes points to the location of the corresponding first-level FIFO (and/or associated second-level distributor or SLD) of the crossbar layer. The 16 LUT entries may therefore be set up by the host to {Engine-0(Index 0), Engine-1(Index 1), Engine-2(Index 2), . . . , Engine-15(Index-15)} as shown in a tabular form in FIG. 5B, where it should be understood that Engine-n is actually representative of the crossbar distributor (or the associated first-level ingress FIFO) that corresponds to Engine-n due to the 1-to-1 correspondence relationship. On the other hand, if the programmable device 503 is operative to support only four engines 550A-550D as illustrated in FIG. 5A, the host 502 may configure the 16 LUT entries to distribute the ingress packets to each engine (and associated FIFO-distributor combination) in a manner to achieve at least some level of load balancing. If there is no performance discrepancy or disparity among the four engines, for example, a distribution mapping of four index values per each engine may be provided in order to balance the work flow of the engines, as shown in the LUT structure 500C of FIG. 5C. As illustrated, Index-0, Index-4, Index-8 and Index-12 point to the first-level FIFO (and associated crossbar distributor) corresponding to Engine-0. Likewise, the remaining sets (each containing four indices) point to the crossbar distributors corresponding to Engine-1, Engine-2 and Engine-3. One skilled in the art will readily recognize this load balancing scheme may be modified in a number of variations depending on such parameters as flow/performance metrics, internal packet congestion, processing speeds, engine latencies, and the like.

In normal mode of operation, all four crossbar distributors 530A-530D are operative to forward the ingress packets to the respective particular application service engines for processing, wherein the crossbar distributors 530A-530D receive the ingress packets as distributed by the first-level ingress distributor 518. In an illustrative ISFU scenario, assuming that application service engine 550A is being upgraded, the crossbar distributor 530A corresponding to that engine is configured or reconfigured to operate in redirect mode whereby the ingress packets received from the first-level distributor 518 may be redirected or redistributed based on a second-level LUT that may be initialized by the host 502 at an appropriate time, preferably prior to initiating the IFSU procedure. FIGS. 5D and 5E depict an example LUT structure 500D and redistribution scheme 500E of ingress packets based on a 4-bit second-level distribution tag. Assuming that application service engine 550A is identified as Engine-0, and further in consideration of load balancing, ingress packets received by the crossbar distributor 530A (originally targeted to the second-level FIFO associated with Engine-0) may be redistributed to the remaining application service engines 5508 through 550D, respectively identified as Engine-1, Engine-2 and Engine-3, for the duration of the upgrade procedure. In the example LUT structure 500D shown in FIG. 5D, the host configures or pre-configures the 16 LUT entries such that the 16 second-level indexes are distributed among the three active application engines, Engine-1, Engine-2 and Engine-3, in a fair and balanced manner, while excluding Engine-0 that is being upgraded. As one skilled in the art will recognize, a number of loading schemes (e.g., weighted balancing, etc.) may also be implemented at the second-level redistribution under the host control, which may be dynamically rearranged based on performance metrics and the like. In the redistribution scheme 500E exemplified in FIG. 5E, Engine-0 is shown as being decommissioned (e.g., due to the upgrading procedure), whereas Engine-1 receives 6/16^{th} of all ingress packets received at the crossbar distributor 530A, Engine-2 receives 5/16^{th} of all ingress packets received at the crossbar distributor 530A and Engine-3 receives 5/16^{th} of all ingress packets received at the crossbar distributor 530A, in addition to packets forwarded by their own corresponding crossbar distributors operating in normal mode. As illustrated in FIG. 5A, an ingress packet 532 received at the crossbar distributor 530A (via the first-level ingress FIFO 526A) is interrogated against a LUT 534 (which may be implemented as LUT 500D described above) to redirect the packet to the scheduler 542D servicing the second-level FIFO 540D for facilitating service process by the application service engine 550D (i.e., Engine-3).

As noted hereinabove, egress packet flow remains unaffected insofar as the active application service engines emit the processed packets that are normally bridged from the corresponding second-level egress FIFOs 543B-543D to the corresponding first-level egress FIFOs 527B-527D. Thereafter, a scheduler 560 operating as part of the aggregation layer 504 is operative to transmit the processed packets to the intended host device 502, as illustrated by a dotted line communication path 561.

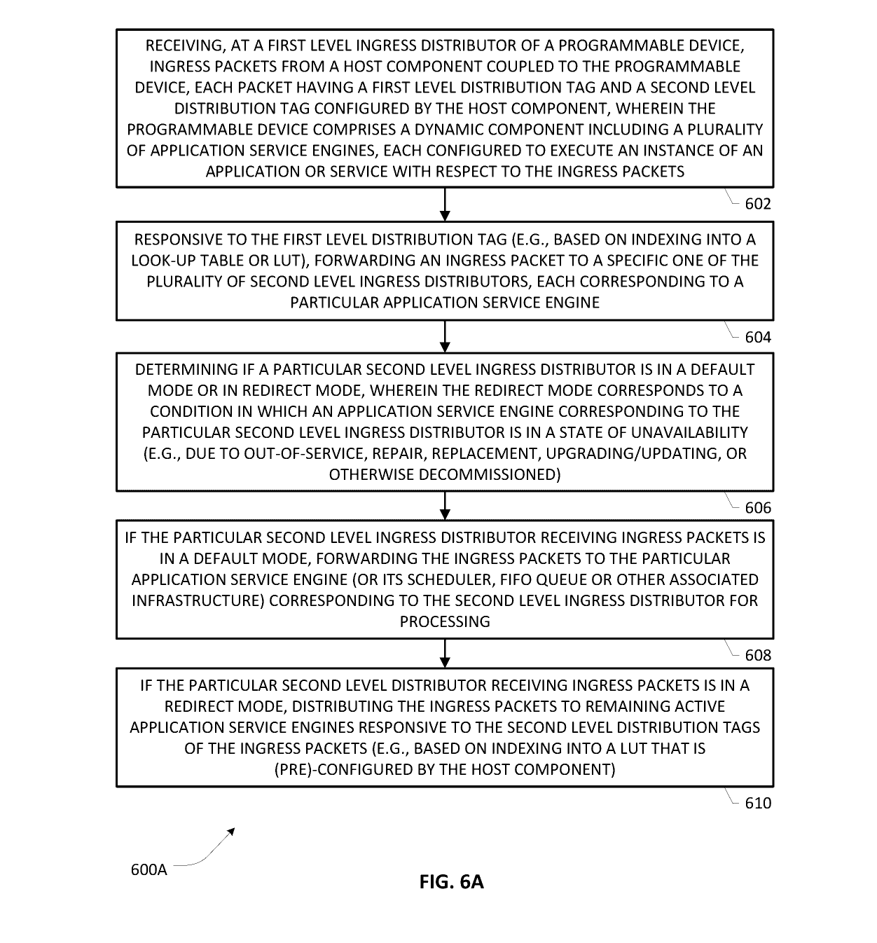

Turning to FIG. 6A, depicted therein is a flowchart of various blocks, steps, acts and functions that may take place as part of a process 600A at a programmable device and/or in a network element including the programmable device for supporting in-service application or firmware upgradability according to an embodiment. At block 602, a first-level ingress distributor of a programmable device of the network element receives ingress packets from a host component coupled to the programmable device, each ingress packet having a first-level distribution tag, a second-level distribution tag and a host identifier configured by the host component, wherein the programmable device comprises a dynamic component including a plurality of application service engines, each configured to execute an instance of an application service with respect to the ingress packets. Responsive to the first-level distribution tag, an ingress packet is forwarded to a specific one of a plurality of second-level ingress distributors, each corresponding to a particular application service engine of the plurality of application service engines (block 604). As described in detail, an example distribution mechanism may involve interrogating an LUT that is indexed based on the first-level distribution tag. A determination may be made if a particular second-level ingress distributor is in a default mode or in a redirect mode, wherein the redirect mode corresponds to a condition/status in which an application service engine associated with the particular second-level ingress distributor is in a state of unavailability (e.g., due to an upgrade procedure) and the default mode corresponds to a condition/status in which the application service engine corresponding to the particular second-level ingress distributor is in an active state (block 606). If the particular second-level ingress distributor is in default mode, the ingress packets are forwarded to the particular application service engine associated with the particular second-level ingress distributor for processing (block 608). On the other hand, if the particular second-level ingress distributor is in redirect mode, the ingress packets may be redistributed to remaining active application service engines for processing, responsive to the second-level distribution tags of the ingress packets (block 608).

Reference numeral 600B in FIG. 6B refers to a return path process that may take place after the ingress packets have been processed by the programmable device as set forth in process 600A. At block 652, an ingress packet is processed at an application service engine as may be required according to the particular application service supported by the programmable device, to result in an egress packet wherein the host identifier or tag that was configured by the host device remains untouched while the first- and second-level distribution tags are removed. The egress packets are then returned or forwarded to the host device via a default path that may be effectuated by a return path scheduler (block 654).

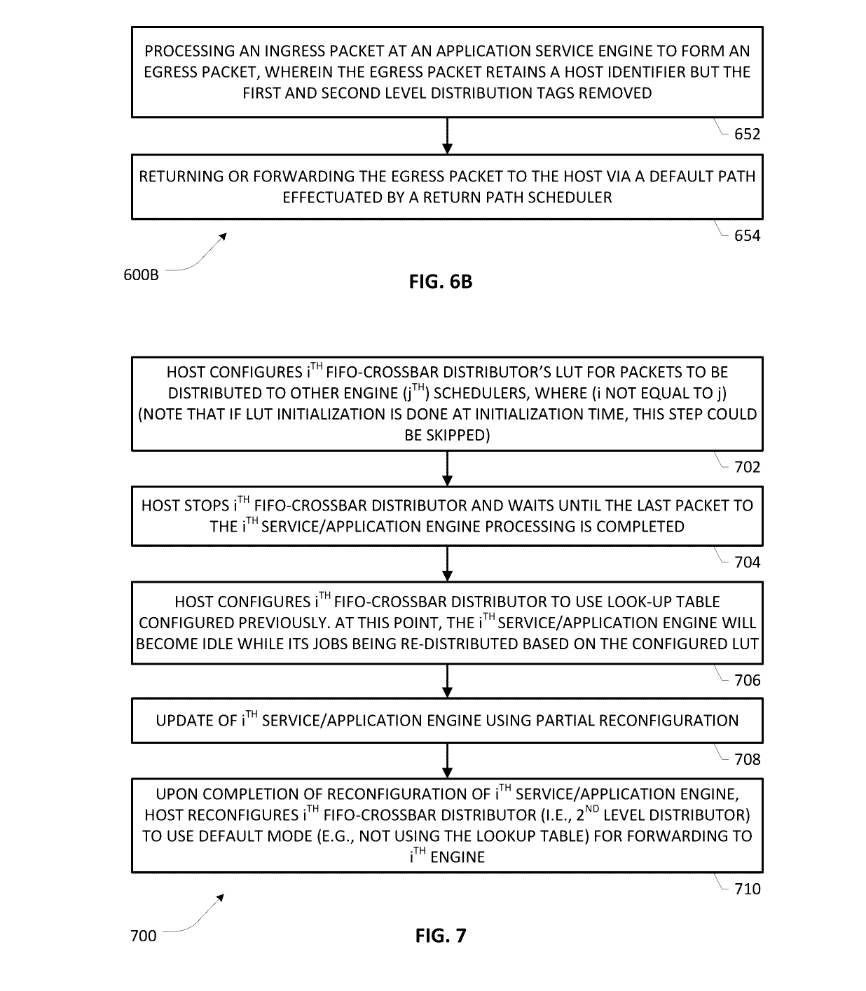

FIG. 7 depicts a flowchart of a scheme 700 for effectuating in-service application or firmware upgradability according to an embodiment of the present invention. At block 702, a host configures, with respect to a programmable device, i^{th} FIFO-crossbar distributor's LUT for packets to be distributed to other engine (j^{th}) schedulers, where i is not equal to j. It should be noted that if LUT configuration has been done at initialization time, this step may be skipped. Thereafter, the host may be configured to stop i^{th} FIFO-crossbar distributor and wait for a configurable period of time so that the processing of all the packets scheduled to the i^{th} service/application engine is completed (block 704). The host is operative to configure the i^{th} FIFO-crossbar distributor to use the LUT configured previously, i.e., in redirect mode. At this point, the i^{th} service/application engine becomes idle while its jobs (i.e., packet flows requiring service processing) are redistributed based on the configured LUT (block 706). The i^{th} service/application engine may be upgraded using such techniques as partial reconfiguration, for example (block 708). Upon completion of reconfiguration of the ith service/application engine, the host reconfigures the i^{th} FIFO-crossbar distributor (i.e., second-level ingress distributor) to use default mode of operation (e.g., not using the LUT) for commencing forwarding of the packets to the i^{th} engine (block 710). As one skilled in the art will recognize, instead of providing a separate default mode that does not involve a LUT, in one variation the programmable device may provide two separate second-level LUTs for the crossbar distributors, wherein a crossbar distributor may switch between using one LUT or the other, to achieve packet redistribution when needed.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and may not be interpreted in an idealized or overly formal sense expressly so defined herein.

It should be appreciated that although service engine replacement has been described herein, packet redistribution in the context of incremental patches, upgrades, etc. pertaining to the firmware within an engine may also be practiced in accordance with the teachings herein. Additionally, packet redistribution in a scenario where multiple service engines, potentially performing different applications on a programmable device, are being replaced are upgraded is also deemed to be within the ambit of the present disclosure.

At least some example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits, logic gate arrangements, etc. For example, such computer program instructions may be provided to a processor circuit of a general purpose computer circuit, special purpose computer circuit, and/or other programmable data processing circuit to produce a machine, so that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). Additionally, the computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

As alluded to previously, tangible, non-transitory computer-readable medium may include an electronic, magnetic, optical, electromagnetic, or semiconductor data storage system, apparatus, or device. More specific examples of the computer-readable medium containing program instructions and/or application service engines for replacement would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray). The computer program instructions may also be loaded onto or otherwise downloaded to a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

Further, in at least some additional or alternative implementations, the functions/acts described in the blocks may occur out of the order shown in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated and blocks from different flowcharts may be combined, rearranged, and/or reconfigured into additional flowcharts in any combination or subcombination. Moreover, although some of the diagrams include arrows on communication paths to show a primary direction of communication, it is to be understood that communication may occur in the opposite direction relative to the depicted arrows.

Although various embodiments have been shown and described in detail, the claims are not limited to any particular embodiment or example. None of the above Detailed Description should be read as implying that any particular component, module, element, step, act, or function is essential such that it must be included in the scope of the claims. Reference to an element in the singular is not intended to mean “one and only one” unless explicitly so stated, but rather “one or more” or “at least one”. All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

What is claimed is:

1. A method operating at a network element configured to support in-service application upgradability, the method comprising:
receiving, at a first-level ingress distributor of a programmable device of the network element, ingress packets from a host component coupled to the programmable device, each ingress packet having a first-level distribution tag, a second-level distribution tag and a host identifier configured by the host component, wherein the programmable device comprises a dynamic component including a plurality of application service engines, each configured to execute an instance of an application service with respect to the ingress packets;
responsive to the first-level distribution tag, forwarding an ingress packet to a specific one of a plurality of second-level ingress distributors, each corresponding to a particular application service engine of the plurality of application service engines;
determining if a particular second-level ingress distributor is in a default mode or in a redirect mode, wherein the redirect mode corresponds to a condition in which an application service engine associated with the particular second-level ingress distributor is in a state of unavailability and the default mode corresponds to a condition in which the application service engine corresponding to the particular second-level ingress distributor is in an active state;
if the particular second-level ingress distributor is in default mode, forwarding the ingress packets to the particular application service engine associated with the particular second-level ingress distributor for processing; and
if the particular second-level ingress distributor is in redirect mode, distributing the ingress packets to remaining active application service engines for processing, responsive to the second-level distribution tags of the ingress packets.

2. The method as recited in claim 1, wherein the first-level distribution and the second-level distribution tags each comprise N-bit random numbers provided by the host component.

3. The method as recited in claim 1, wherein the plurality of application service engines are configured to execute an application service comprising at least one of an Internet Protocol security (IPsec) service, Deep Packet Inspection (DPI) service, Firewall filtering service, Intrusion Detection and Prevention (IDP) service, Network Address Translation (NAT) service, and a Virus Scanning service.

4. The method as recited in claim 1, further comprising:
processing an ingress packet by an application service engine to form an egress packet wherein the first-level and second-level distribution tags are removed and the host identifier is retained; and
returning the egress packet to the host component via a default path effectuated by a return path scheduler.

5. The method as recited in claim 1, wherein the programmable device comprises at least one of a Field-Programmable Gate Array (FPGA) device, a Programmable Logic Device (PLD), a Programmable Array Logic (PAL) device, a Field Programmable Logic Array (FPLA) device, and a Generic Array Logic (GAL) device.

6. The method as recited in claim 1, wherein the first-level distribution tags are indexed into a look-up table (LUT) configured by the host component for distributing the ingress packets to the plurality of second-level ingress distributors in a load-balanced fashion.

7. The method as recited in claim 1, wherein the second-level distribution tags are indexed into a look-up table (LUT) configured by the host component for distributing the ingress packets received at the particular second-level ingress distributor operating in redirect mode to the remaining active application service engines in a load-balanced manner.

8. The method as recited in claim 1, wherein the particular second-level ingress distributor is configured to be in redirect mode by the host component when the application service engine corresponding to the particular second-level ingress distributor is being upgraded.

9. The method as recited in claim 8, further comprising:
upon completion of upgrading the application service engine corresponding to the particular second-level ingress distributor, reconfiguring the particular second-level ingress distributor to operate in default mode; and
commencing forwarding of the ingress packets received by the particular second-level ingress distributor to the corresponding application service engine.

10. A programmable device adapted to perform an application service, the programmable device comprising:
an aggregation layer component configured to distribute ingress packets received from a host device to a plurality of crossbar distributors forming a crossbar layer component of the programmable device; and
an admission layer component operably coupled between a plurality of application service engines and the crossbar layer component for facilitating transfer of ingress packets and processed egress packets,
wherein each crossbar distributor, when configured to operate in a default mode, forwards received ingress packets to a specific corresponding application service engine for processing, and
wherein if a particular crossbar distributor is configured to operate in a redirect mode, the particular crossbar distributor is adapted to distribute received ingress packets to a subset of the plurality of the application service engines excluding the specific application service engine corresponding to the particular crossbar distributor.

11. The programmable device as recited in claim 10, wherein the aggregation layer component is configured to distribute the received ingress packets based on first-level distribution tags appended to the ingress packets by the host device for indexing into a look-up table (LUT).

12. The programmable device as recited in claim 10, wherein the particular crossbar distributor configured to operate in redirect mode is adapted to distribute the received ingress packets to the subset of the plurality of application service engines based on second-level distribution tags appended to the ingress packets by the host device for indexing into a look-up table (LUT).

13. A network element, comprising:
one or more processors;
a programmable device supporting a plurality of application service engines configured to execute an application service, wherein the programmable device comprises a layered packet distribution mechanism that includes an aggregation layer component for distributing ingress packets to a crossbar layer component configured to selectively bypass a particular application service engine and redirect the ingress packets to remaining application service engines; and
a persistent memory module coupled to the one or more processors and having program instructions for configuring the aggregation layer and crossbar layer components in order to effectuate in-service firmware upgradability of the programmable device.

14. The network element as recited in claim 13, wherein the plurality of application service engines are configured to execute an application service with respect to the ingress packets, the application service comprising at least one of an Internet Protocol security (IPsec) service, Deep Packet Inspection (DPI) service, Firewall filtering service, Intrusion Detection and Prevention (IDP) service, Network Address Translation (NAT) service, and a Virus Scanning service.

15. The network element as recited in claim 13, wherein the programmable device comprises at least one of a Field-Programmable Gate Array (FPGA) device, a Programmable Logic Device (PLD), a Programmable Array Logic (PAL) device, a Field Programmable Logic Array (FPLA) device, and a Generic Array Logic (GAL) device.

16. The network element as recited in claim 13, wherein the program instructions comprise instructions for appending a first-level distribution tag, a second-level distribution tag and a host identifier to each ingress packet, the first-level distribution tag operative to index into a first-level look-up table (LUT) that includes location information related to a plurality of crossbar distributors forming the crossbar layer component, to which the ingress packets are distributed, and the second-level distribution tag operative to index into a second-level LUT used by a particular crossbar distributor in a redirect mode for bypassing the application service engine associated therewith and for distributing the ingress packets to the remaining application service engines of the programmable device.

17. The network element as recited in claim 16, wherein the first-level distribution and the second-level distribution tags each comprise N-bit random numbers.

18. The network element as recited in claim 13, wherein the programmable device further comprises an admission layer component operably coupled between the plurality of application service engines and the crossbar layer component for facilitating transfer of the ingress packets and processed egress packets.

19. The network element as recited in claim 18, wherein the admission layer component comprises a plurality of ingress First-In-First-Out (FIFO) structures, each corresponding to a specific one of the plurality of application service engines.

20. The network element as recited in claim 19, wherein each ingress FIFO structure is serviced by a scheduler for scheduling ingress packets to a corresponding application service engine.
